(19) United States
(12) Patent Application Publication
(10) Pub. No.: US 2011/0087698 A1
(43) Pub. Date: Apr. 14, 2011

(54) SEARCH EXPRESSION CREATING SYSTEM, SEARCH EXPRESSION CREATING METHOD, SEARCH EXPRESSION CREATING PROGRAM, AND RECORDING MEDIUM

(76) Inventor: Keiichi Iguchi, Tokyo (JP)

(21) Appl. No.: 12/996,918

(22) PCT Filed: Jun. 17, 2009
(86) PCT No.: PCT/JP2009/061056

§ 371 Date: Dec. 8, 2010

(30) Foreign Application Priority Data
Jun. 18, 2008 (JP) 2008-159160

(51) Int. Cl. G06F 17/30

(52) U.S. Cl. 707/769; 707/E17.014

(57) ABSTRACT

To provide a search expression creating system enabling the creating of a search expression by showing an example even if the interpretation by a structure analysis means used for showing an example is different from that by a structure analysis means used for search, and the generation of a search expression for a plurality of structure analysis means which perform different interpretations.

A search expression creating system of the present invention includes an identifier giving means for adding an identifier to an element of a structured document as an attribute independent of structure analysis, a search element specifying means for analyzing the structured document to which the identifier is added, receiving an input of the search target element from the user, and obtaining the identifier added to the inputted search target element, and a search expression creating means for analyzing the structured document to which the identifier is added, receiving an input of the identifier corresponding to the search target element from the search element specifying means, searching the search target element from the analyzed structure by using the inputted identifier, and creating a search expression indicating the structural position of the search target element.

### TECHNICAL FIELD

The present invention relates to a search expression creating system, a search expression creating method, a search method creating program, and recording medium, and in particular, relates to an art which is preferably applied to the generation of a search expression corresponding to a plurality of structured document analyzing systems that interpretation are different.

### BACKGROUND ART

When searching a specific element in a structured document, XPath for example is known for a language (non-patent document 1), however, in order to address a search expression by the XPath, a certain degree of proficiency is needed. For example, in patent document 1, an example of a search expression creating support system is disclosed as an art to support the address of an XPath search expression. The search expression creating support system is provided with memorizing means which a structured document is stored, structure extraction means for extracting a partial structure of a structured document exemplified from the user as one of search results, and search expression synthesizing means for synthesizing a search expression from a partial structure extracted by the structure extraction means. And the search expression creating support system having such configuration operates as summarized below. That is, the user exemplifies a part to search, from a knowledge base, extracts a partial structure having the same pattern with a structure of an element exemplified, and synthesizes a search expression from an extracted partial structure.

Further, for example in patent document 2, a document registration retrieval method capable of realizing a structure assignment search at high speeds which designates only a logical structure aimed at as a target is disclosed. In the invention in the patent document 2, to character string data set with a high possibility of having referred to in a lump when searched, a designated index group identifier is given. The invention gives the index group identifier to character string data which appeared in a registration object document. The invention generates a structure index composed of a tree structure of meta element group and metacharacter group. Further, the invention binds together a context identifier and the index group identifier of the structure index to the character string data belonging to each logical structure appeared in a document to be registered. The invention stores and manages a document identifier of the character string data, a context identifier, and structured character position information, for each index group identifier.

Further, for example patent document 3 discloses a sentence analyzer which can output an analysis result that is easy for a person to understand. The analyzer includes an analysis unit consist of a split part, a language analysis part, a new density calculation part, and a selection part. Each part of the analyzer, by operating as follows, outputs an analysis result that is easy for a person to understand. The split part splits the inputted sentences by word by word. The language analysis part performs syntactic and semantic analysis such as syntax analysis and semantic analysis, to a split candidate (split sentences). Then, the language analysis part generates analysis candidates having a plurality of different analytical structure. A new density calculation part extracts a new density of each word included in each analysis candidate from a memory unit. The new density calculation part calculates by each analysis candidate, the average of said new density included in the sentence. A selection part extracts an analysis structure having the highest average of density from plurality of analysis candidates.

Further, for example in patent document 4, a structured document retrieval system which can obtain an appropriate search result by only inputting a plurality of character strings and performing a search for a structured document by considering hierarchical relationships among character strings is disclosed. The system has a data analysis part, a retrieval execution part, a memory unit, and each part operates as follows. The data analysis part generates data which shows hierarchical relationships among vocabulary included in each document by corresponding to each structured document of a search target. The retrieval execution part generates a search expression of a structured document matching to the hierarchical relationships among the vocabulary, by referring to the generated data. The retrieval execution part performs a creation of said search expression based on the hierarchical relationships among a plurality of character strings which is shown by vocabulary hierarchical relationships data including the plurality of character strings included in a search condition from a retriever as a vocabulary. The memory unit searches the structured document which matches with said search expression, based on the created search expression.

### RELATED ART DOCUMENTS

### Non-Patent Document

[non-patent document 1] James Clark, Steve DeRose. (1999, Nov. 16). XML XPath Language (XPath) Version 1.0. W3C Recommendation. Retrieved Jun. 5, 2008, from http://www.w3.org/TR/xpath

### Patent Document

[patent document 1] Japanese Patent Laid-Open No. 1995-225771
[patent document 2] Japanese Patent Laid-Open No. 2000-3366
[patent document 3] Japanese Patent Laid-Open No. 2007-11774
[patent document 4] Japanese Patent Laid-Open No. 2008-65543

### SUMMARY OF INVENTION

### Technical Problem

In the patent document 1, when different structure analysis means relating not to the search expression creating system is used, the search expression generated in the search expression creating system is not be correctly interpreted. This is because the search expression creating system relates to only one structure analysis means, or because the other structure analysis means which performs different interpretation is not considered. However, in reality, a plurality of structure analysis means exists, and each interprets the structured document differently, and may create different structure trees.

Especially for the interpretation of HTML which is one of the structured document, when an HTML document is not depending on a perfect designated format, the structure analysis means creates a structure tree by a specific interpretation. An example of different interpretation is shown in FIG. 1. For example, by a designation of a format of the structured document, it is supposed that “a tbody element exists in a table element, and further tr element exists therein” is decided. In this case, structure analysis means A interprets by adding the tbody element to a structure tree according to the designated format (structure tree 120 is built). In contrast, structure analysis means B builds a structure tree 130 with a different format.

Further, for another example, the case “having a structured document described by a start tag and an end tag of elements, and the start tag and the end tag of each element should not intersect” is considered. In this case, supposed that, by violating the format, it was described in order of the start tag of element a, the start tag of element b, the end tag of element a, and the end tag of element b. In that case, by the structure analysis means, the interpretation differs between whether to have element a and element b as parent-child relationship or as sibling relationship. Further, such differences among the interpretation exist numerously, thus it is difficult to create a correspondence relationship table.

The differences in interpretations as described above, are not used as a target of the search expression creating system because it is a defect of the structured document nor a defect of the structure analysis means. However, in reality, a plurality of structure analysis means exist. Moreover, in order to use a structured document not perfectly depending on a structure definition as a processing target, the search expression creating system that can generate a search expression targeting for said document is required.

The first problem of the search expression creating system of patent document 1 is that when interpretation performed by the structure analysis means used for showing an example is different from that performed by the structure analysis means used for search, a search expression for the structure analysis means used for search cannot be generated. The reason is as follows. Up to now, it was assumed that both the structure analysis means used for showing the example and structure analysis means used for search are identical or a structured document for search target can be interpreted uniquely in all structure analysis means, or even all structure analysis means are compatible with each other. The search expression creating support system of patent document 1 generates the search expression by extracting a partial structure (a subtree) having a structure matching with the element specified in the structured document for showing the example built in a memory. Therefore, the search expression creating support system cannot specify the structural position in a structure tree which the structure analysis means used for search of a specified element builds.

The second problem of the search expression creating support system of patent document 1 is that it cannot generate the search expression for a plurality of search analysis means performing different interpretations. The reason is as follows. Structure analysis means performing different interpretations builds different structure trees respectively. However, the search expression creating support system of patent document 1 assumes a particular structure tree. Therefore, the search expression creating support system cannot identify the structural position of search target element in the structure tree built by the other structure analysis means.

Considering the problems of patent document 1, it can be said that it is effective to enable unique identification among varieties of the structure analysis means. In this respect, patent document 2 adopts a method to assign an identifier to structure tree information which is already analyzed (further, the method to assign the identifier before an analysis is not particularly disclosed). However, in this case, because it would be strongly depended on the variation of structure analysis means, the art disclosed in patent document 2 is difficult for unique identification among said variations. Moreover from the above-mentioned problems, it is desirable to be able to generate XPath search expression of said element by identifying an identical element to a different structure. In this respect, patent document 3 describes to have a plurality of different structure as a processing target. However, patent document 3 does not disclose a method to identify an identical element therein. Further from the above-mentioned problems, it is desirable to have the user to be able to identify a specified element based on different structures. In this respect, patent document 4 adopts a method to designate an object creating a search expression by a plurality of vocabulary. However, with this method, patent document 4 cannot uniquely designate when object vocabulary appear at multiple parts.

In view of circumstances mentioned above, the primary object of the present invention is therefore to provide a search expression creating system enabling the creating of a search expression by showing an example even if the interpretation by structure analysis means used for showing an example is different from that by structure analysis means used for search. Further, the secondary object of the invention is therefore to provide a search expression creating system enabling the creating of a search expression for a plurality of structure analysis means which perform different interpretations.

### Solution to Problem

In order to achieve the target, a search expression creating system of the present invention includes, identifier giving means for adding an identifier to an element of a structured document as an attribute independent of structure analysis, search element specifying means for analyzing the structured document to which the identifier is added, receiving an input of the search target element from the user, and obtaining the identifier added to the inputted search target element; and search expression creating means for analyzing the structured document to which the identifier is added, receiving an input of the identifier corresponding to the search target element from the search element specifying means, searching the search target element from said analyzed structure by using the inputted identifier, and creating a search expression indicating the structural position of said search target element.

Further, a search expression creating method of the present invention includes identifier giving step for adding an identifier to an element of a structured document as an attribute independent of structure analysis, search element specifying step for analyzing the structured document to which the identifier is added, receiving an input of the search target element from the user, and obtaining the identifier added to the inputted search target element; and search expression creating step for analyzing a structured document to which the identifier is added, receiving an input of an identifier corresponding to said search target element from the search element specifying step, searching the search target element from analyzed structure by using the inputted identifier, and creating a search expression indicating the structural position of said search target element.

Further, a search expression creating program of the present invention is a search expression creating program used for search expression creating system having memorizing means and operation input means, further have a computer to realize an identifier giving function for adding an identifier to an element of a structured document read from the memorizing means or obtained from external devices as an attribute independent of structure analysis and storing in the memorizing means, a search element specifying function for analyzing the structured document to which the identifier is added from the memorizing means by reading, receiving an input of the search target element by the operation input means from the user, and obtaining the identifier added to the inputted search target element, and a search expression creating function for analyzing the structured document to which the identifier is added from the memorizing means by reading, receiving an input of the identifier corresponding to the search target element from the search element specifying function, searching the search target element from tell analyzed structure by using the inputted identifier, and creating a search expression indicating the structural position of said search target element.

Further, a recording medium of the present invention is a computer readable recording medium having the above-mentioned program recorded.

### EFFECTS OF INVENTION

The primary effect of the present invention is to be able to generate a search expression by showing an example even if the interpretation by a structure analysis means used for showing an example is different from that by a structure analysis means used for search. The reason is because the present invention builds a structure tree for showing an example and a structure tree for search respectively, and to specify a search object element by an identifier not depending on the structure analysis means added to a structured document. Further, the second effect of the present invention is to be able to generate a search expression for a plurality of structure analysis means which perform different interpretations. The reason is because the present invention builds a structure tree for showing an example and a structure tree for search respectively for each objected structure analysis means for search, and generate respectively a search expression indicating a structural position in each structure tree for search.

### BRIEF DESCRIPTION OF THE DRAWINGS

FIG. 1 It is a diagram of illustrating different HTML interpretation for each structure analysis means;

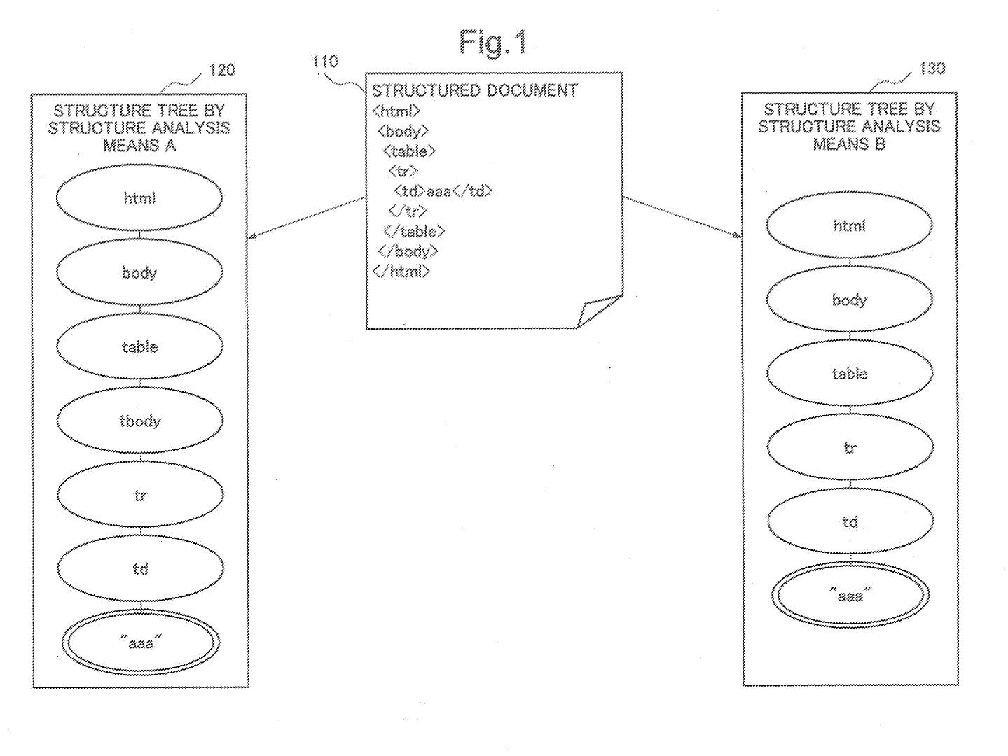

FIG. 2 It is a diagram showing a composition of a search expression creating system according to an exemplary embodiment of the present invention;

FIG. 3 It is a flowchart showing an overall flow of a search expression creating operation in the exemplary embodiment of the present invention;

FIG. 4 It is a flowchart showing a flow of an example of a search expression generation (an H) example of a generation of XPath expression designating an element in XML) in the exemplary embodiment of the present invention;

FIG. 5 It is a diagram showing a composition of HTML editing rule description system to which the search expression creating system according to the exemplary embodiment of the present invention is applied to;

FIG. 6 It is a flowchart showing an overall flow of the search expression creating operation according to the exemplary embodiment of the present invention;

FIG. 7 It is a diagram illustrating a structure of the HTML document according to the exemplary embodiment of the present invention;

FIG. 8 It is a diagram illustrating a structure of the HTML document with an identifier according to the exemplary embodiment of the present invention; and

FIG. 9 It is a diagram illustrating the contents of the HTML editing rule according to the exemplary embodiment of the present invention.

### MODE FOR CARRYING OUT THE INVENTION

A search expression creating system of the present invention includes identifier giving means, search element specifying means, and search expression creating means. The search element specifying means has structure analysis means for showing an example. The search expression creating means has one or more structure analysis means for search.

The identifier giving means gives a unique identifier to all the elements in the structured document as an attribute independent of structure analysis means. The structure analysis means for showing an example analyzes the structure document to which the identifier is added, creates a structure tree for showing an example, and inputs to the search element specifying means. The search element specifying means presents the inputted structure tree showing an example to the user, obtains an attribute representing the identifier from an element specified by the user (search target element), and inputs to the search expression creating means. The structure analysis means for search creates a structure tree for search by analyzing the structured document from the search element specifying means, and inputs to the search expression creating means. The search expression creating means searches elements having the inputted identifier from within each of the inputted structure tree for search, and generates a search expression indicating the structural position of said element for each structure tree for search.

The search expression creating system of the present invention specifies a search target element by using an identifier independent from the structure analysis means which is added to the structured document in a form without influencing the structure. The search expression creating system of the present invention creates a structure tree for search for each structure analysis means used for search. The search expression creating system of the present invention creates a search expression showing the structural position for each structure tree for search of the search target element. The search expression creating system of the present invention can achieve the object of the present invention by adopting such compositions.

The following will describe an exemplary embodiment of the present invention in detail by referring to the drawings. Further, the exemplary embodiment to be hereinafter described is a preferred exemplary embodiment of the present invention, therefore technologically preferred various limitation is attached. However, the scope of the present invention is not limited to such exemplary embodiments as far as there is no description of especially limiting to the present invention in the following description.

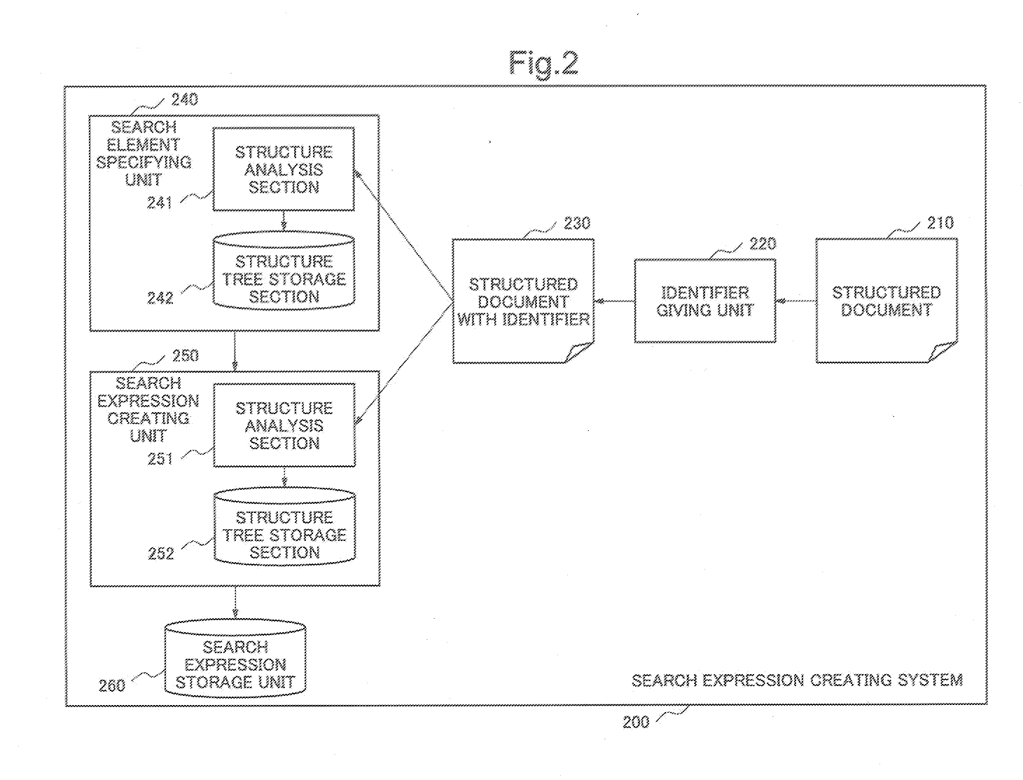

FIG. 2 is a diagram showing a composition of the search expression creating system according to the exemplary embodiment of the present invention. Search expression creating system 200 of the present invention is configured to have structured document 210 for specifying a search target, identifier giving unit 220 for giving an identifier to each element of structured document 210, structured document with identifier 230 to which identifier is added by identifier giving unit 220, search target specifying unit 240 for specifying the search target by presenting the structured document to the user, search expression creating unit 250 for creating a search expression of each structured analysis section, and search expression storage unit 260 for storing the generated search expression.

Search element specifying unit 240 includes structure analysis section 241 for building a structure tree to present to the user, and structure tree storage section 242 for storing the structure tree built by structure analysis section 241.

Search expression creating unit 250 includes one or more structure analysis section 251 which is an target of creating a search expression, and structure analysis storage section 252 for storing the structure tree which structure analysis section 251 has built.

The elements operate as follows.

Identifier giving unit 220 reads structured document 210 and adds identifier to each element of structured document 210 in the form of being independent from the structure analysis unit. A preferred method for adding is to add a unique attribute value to each element. By adding in the form of attribute value, without changing the structure of structured document 210, identifier giving unit 220 can give identifier in a form of not losing identifier information in many of structure analysis section 251. Further identifier giving unit 220 sequentially analyzes the structured document without creating a structure tree, and by inserting a character string for attribute at a starting position of an element, can add an identifier independent from a particular structure analysis section.

Search element specifying unit 240 analyzes inputted structured document with identifier 230 by structure analysis section 241, and builds a structure tree. Search element specifying unit 240 stores built structure tree to structure tree storage section 242. Search element specifying unit 240 receives specification on a search target element from instructions of the user. When a search target element is specified, search element specifying unit 240 obtains the identifier given to the element and inputs the identifier to search expression creating unit 250.

Search expression creating unit 250 analyzes structured document with identifier 230 at each structure analysis section 251 and builds a structure tree. Search expression creating unit 250 stores the built structure tree to structure tree storage section 252. Search expression creating unit 250, by searching the inputted identifier from stored structure tree at structure tree storage section 252, specifies the identical target element in each structure tree. Further, search expression creating unit 250 generates a search expression showing a structural position in the structure tree stored in structure tree storage section 252 of said element. Search expression creating unit 250 stores the generated search expression to search expression storage unit 260.

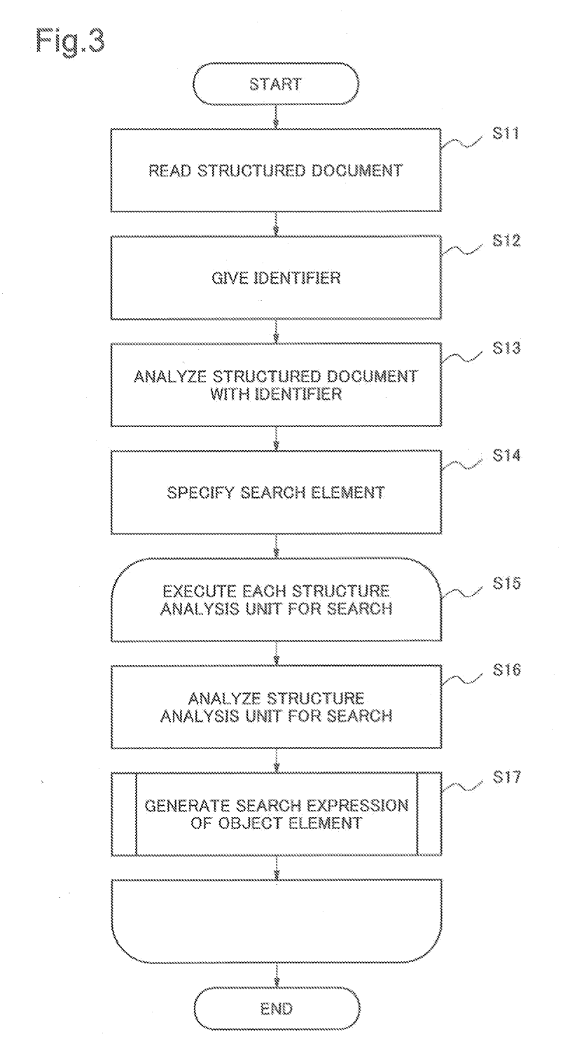

Next, by referring to FIG. 2 and the flowchart of FIG. 3, the overall operation of the present exemplary embodiment will be described in detail.

First, search expression creating system 200 reads structured document 210 for indicating a search target (step S11). Next, identifier giving unit 220, by giving an identifier to structure document 210, and generates structured document with identifier 230 (step S12). Then, structure analysis section 241 analyzes structured document with identifier 230, generates a structure tree and stores in structure tree storage section 242 (step S13).

Next, search element specifying unit 240 presents to the user either the structure tree stored in structure tree storage section 242 or a figure rendered to have the user to easily see a structure tree. Search element specifying unit 240 receives a specification of a search element from the user and inputs an identifier of the specified element to search expression creating unit 250 (step S14). Here, when an identifier does not exist in the element specified by the user, said element is an element not existing in structured document 210 or structured document with identifier 230, and it is an element which structure analysis section 241 has added originally. Therefore, search element specifying unit 240 may be composed as to notify the user the fact of not being able to generate a search expression and to suggest a second specification.

Next, structure analysis section 251 analyzes structured document with identifier 230, builds a structure tree, and stores in structure tree storage section 252 (step S16). Subsequently, search expression creating unit 250 generates a search expression showing the structural position of the inputted identifier related to the generated structure tree (step S17). The process from step 16 to step 17 is performed on each structure analysis section 251 included in search expression creating unit 250 (step S15).

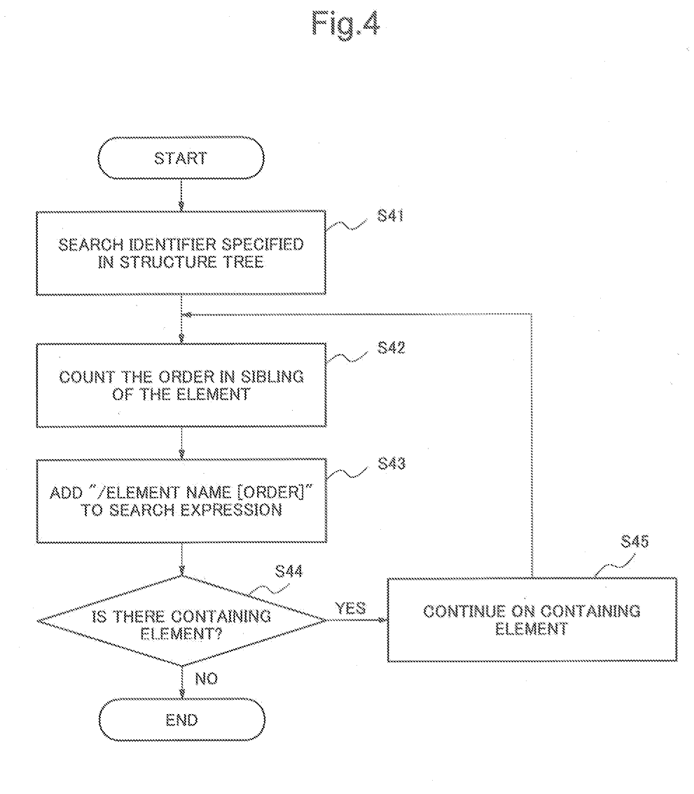

Next, a detailed procedure on a generation of a search expression is shown in the flowchart shown in FIG. 4, taking the case as an example when creating Xpath expression which specifies an element in XML.

First, search expression creating unit 250 searches an element having an inputted identifier from within a structure tree of an target. Subsequently, search expression creating unit 250 counts an appropriate corresponding element on which number of the element it is in the sibling. Next, search expression creating unit 250 uses an element name of the appropriate element and the previous order and adds a description “/element name [order]” (step S43). Further, when other sibling element does not exist, it may be composed as to omit a description on the order. Then, when there is a containing element in the appropriate element (step S44/YES), search expression creating unit 250 continues the process from step S42 as making containing element as an appropriate element.

A search expression built in this way is generated by a form which uniquely specifies the structural position of an target element in an target structure tree as “/html[1]/body[1]/table [1]/tr[1]/td[1]”.

Further, an example of creating a search expression showing a structural position with focusing only on the order is shown here, however it may be composed as to generate a search expression using an ID attribute showing an element uniquely.

Further, search element specifying unit 240 may further generate a search expression for structure analysis section 241 by possessing equal function to search expression creating unit 250. In this case, a search expression generated at search element specifying unit 240 may be composed as to be stored in search expression storage unit 260 with a search expression generated by search expression creating unit 250.

According to the above-mentioned present exemplary embodiment, it will be possible to generate a search expression for a structure analysis section which performs different interpretation with structure analysis section 241 used in search element specifying unit 240. This is because, search element specifying unit 240 and search expression creating unit 250 are to be performing the specification of an target element by using the same identifier added at identifier giving unit 220.

Moreover, according to the above-mentioned present exemplary embodiment, it is further possible to generate a search expression for a plurality of structure analysis sections. This is because search expression creating unit 250 generates a structure tree for each of the one or more structure analysis section, and to have a generation of a search expression specifying a structural position of an target element.

### Example

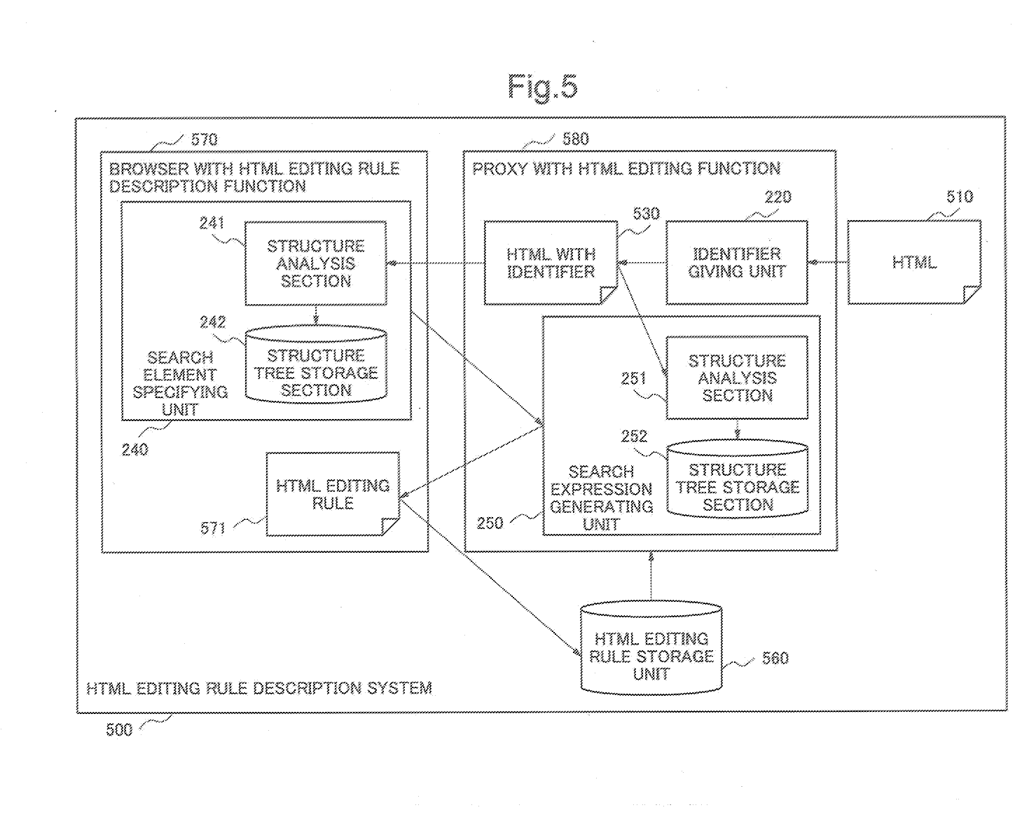

Next, the operation of the preferred exemplary embodiments of the present invention will be described below by referring to detailed exemplary embodiments. FIG. 5 is a diagram showing a composition of HTML editing rule system using a search creating system of the present exemplary embodiment. HTML editing rule description system 500 of the present exemplary embodiment is composed by having HTML for specifying search target 510, Proxy with HTML editing function 580, browser with HTML editing rule description function 570, and HTML editing rule storage unit 560.

Proxy with HTML editing function 580 includes identifier giving unit 220 and search expression creating unit 250. Search expression creating unit 250, as the above exemplary embodiment, has structure analysis section 251 and structure tree storage section 252.

Browser with HTML editing rule description function 570 includes search element specifying unit 240. Search element specifying unit 240, as the above exemplary embodiment, has structure analysis section 241 and structure tree storage section 242.

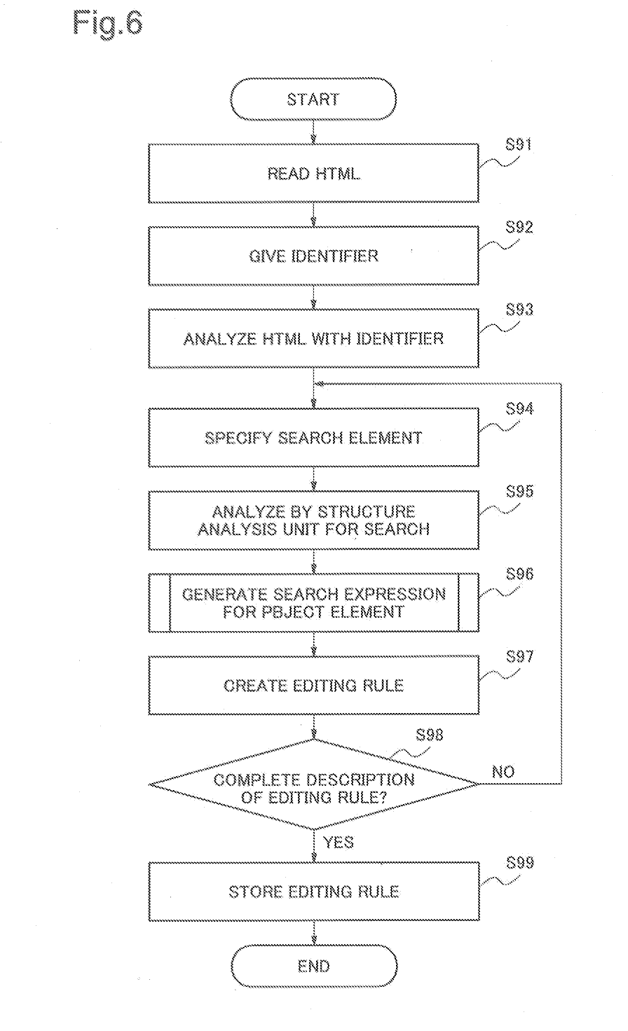

An operation of HTML editing rule description system 500 composed as the above will be explained referring to the flowchart of FIG. 6.

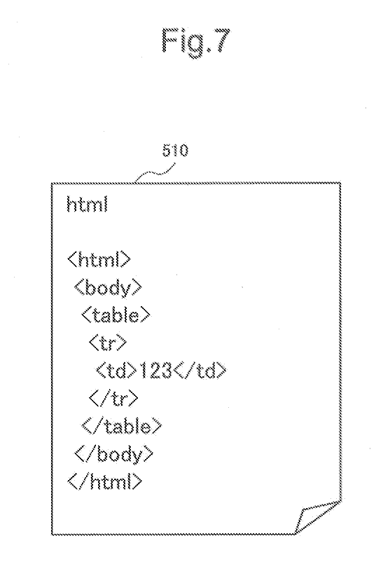

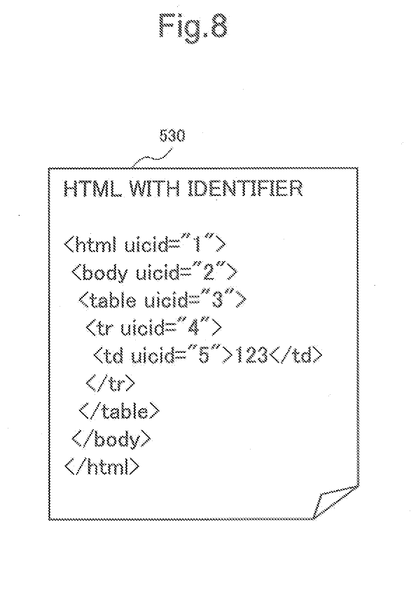

First, HTML editing rule description system 500 reads HTML for specifying search target 510 from an external server that the user specifies via network (S91). A detailed example of HTML 510 is shown in FIG. 7. Next, identifier giving unit 220 gives an identifier to each element of HTML 510 and generates HTML with identifier 530 (S92). The generated HTML with identifier 530 is shown in FIG. 8.

Next, Proxy with HTML editing function 580 sends HTML with identifier 530 to browser with HTML editing rule description function 570. Structure analysis section 241 analyzes HTML with identifier 530 and stored in structure tree storage section 242 which structure tree is composed by a memory (S93). Subsequently, search element specifying unit 240 in browser with HTML editing rule description function 570 displays the analyzed HTML to the user by rendering. Search element specifying unit 240 receives a specification of an element which is an target of creating an editing rule, by the user (S94). Next, search element specifying unit 240 obtains an identifier of an element specified by the user, and inputs the identifier to search expression creating unit 250 in Proxy with HTML editing function 580. Search expression creating unit 250 generates a search expression (S96) for structure analysis section 251 (S95).

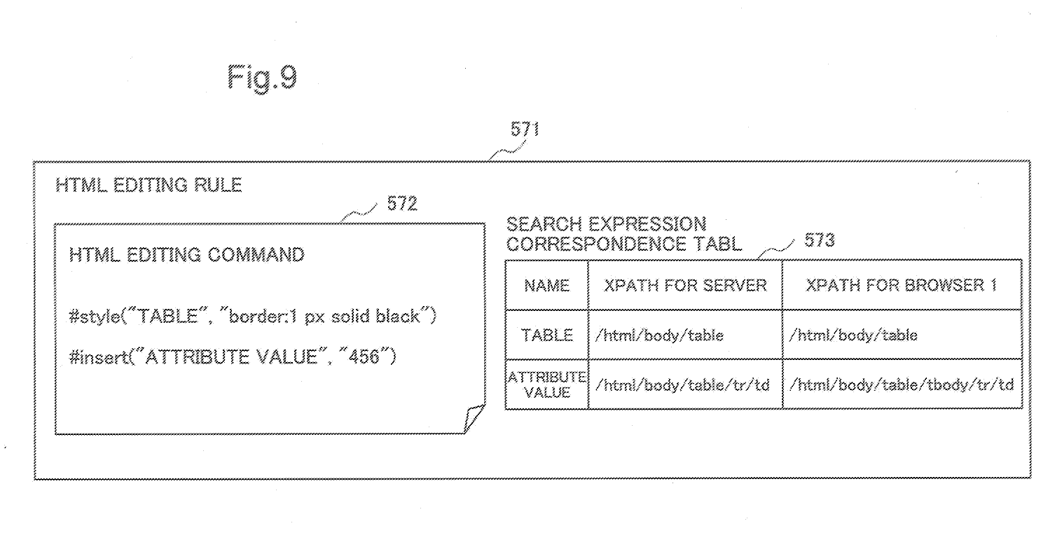

Next, search expression creating unit 250 creates HTML editing rule 571 with an inputted name form the user, a search expression for structure analysis section 251, and a search expression for structure analysis section 241 (S97). HTML editing rule 571, as shown in FIG. 9, consists of search expression correspondence table 573 and HTML editing command 572. Then, until the completion of the description on the editing rule has instructed from the user (step S98/NO), the process from step S94 to step S97 is repeated. When the completion of the description on the editing rule has instructed from the user, HTML editing rule description system 500 stores described HTML editing rule 571 to HTML editing rule storage unit 560 (step S99).

HTML editing rule description system 500 of the present exemplary embodiment operates as described above. As a result, Proxy with HTML editing function 580 can be possible for using the rule stored in HTML editing rule storage unit 560.

By adding a structure analysis section for other browsers to structure analysis section 251, search expression correspondence table 573 may be composed as describing with Xpath for another browser. Further, search expression correspondence table 573 may be composed as to have a column for each type of structure analysis section 251 and 241 to use, and to save Xpath of each structure analysis section. Further, search expression correspondence table 573 may be a composition of having a column for each user, and saving Xpath for structure analysis section to use for each user. Further, search expression correspondence table 573 may be composed as to have a column describing an identifier of target HTML (for example, URL), and to clearly state on which HTML the correspondence is for.

By composing as described above, HTML editing rule 571 becomes possible to be carried out on not only Proxy 580 with HTML editing function but also on various browsers.

The present invention can be applied to, as described in the above mentioned exemplary embodiment, editing rule describing tool for Proxy with HTML editing function which edits HTML in Proxy according to a rule, and moreover it is possible to apply to a usage such as multiple parser compatible Xpath expression creating system.

Though the present invention has been described with respect to a preferred exemplary embodiment, it is not intended to limit the invention to the precise form disclosed. Many variations are possible can be devised to the components or to the description of the present invention by those skilled in the art that will fall within the scope of the principles of this invention.

That is, the program executed by the search expression creating system according to the present exemplary embodiment has a module configuration including aforementioned parts (such as a search element specifying unit, a search expression creating unit, and an identifier giving unit), and a concrete means is realized by using actual hardware. In other words, each of the above-mentioned part is loaded on a main memory device by a computer (CPU) by reading and executing a program from a predetermined recording medium. As a result, a search element specifying unit, a search expression creating unit, an identifier giving unit and the like will be generated on a main memory device.

The program executed in a search expression creating system in the present exemplary embodiment may be composed as to be stored on a computer connected to networks such as the Internet and be provided by having it downloaded via a network. Further, the above-mentioned program may be composed as for providing or distributing via networks such as the Internet.

Further, the above-mentioned program may be composed as to be provided by having it recorded to a computer readable recording medium such as a floppy disk (registered trademark), a hard disk, an optical disk, a Magneto-Optical disk, a CD-ROM, a CD-R, a DVD, and a non-volatile memory card, being a file of a format that can be installed or in a format that can be carried out. Further, the above-mentioned program may be composed as to be provided by having it built in beforehand to ROM or the like.

In this case, a program code itself either read from the above-mentioned recording medium or executed by loading through a communication line is to realize the function of the aforementioned exemplary embodiment. Thus, the recording medium having the program code recorded composes the present invention.

This application claims priority of Japanese Patent Application No. 2008-159160 filed Jun. 18, 2008, the contents of which are hereby incorporated by reference in their entirety.

### DESCRIPTION OF CODE

200 search expression creating system
210 structured document
220, 520 identifier giving unit
230 structured document with identifier
240 search element specifying unit
241, 251 structure analysis section
242, 252 structure tree storage section
250 search expression creating unit
260 search expression storage unit
500 HTML editing rule description system
510 HTML
530 HTML with identifier
560 HTML editing rule storage unit
570 browser with HTML editing rule description function
580 Proxy with HTML editing function

1. A search expression creating system, comprising:
an identifier giving unit which adds an identifier to an element of a structured document as an attribute independent of structure analysis;
a search element specifying unit which analyzes the structured document to which the identifier is added, receives an input of the search target element from the user, and obtains the identifier added to the inputted search target element; and
a search expression creating unit which analyzes the structured document to which the identifier is added, receives an input of the identifier corresponding to the search target element from the search element specifying unit, searches the search target element from said analyzed structure by using the inputted identifier, and creates a search expression indicating the structural position of said search target element.

2. The search expression creating system according to claim 1, wherein:
the search element specifying unit has a structure analysis section for showing an example which creates a structure tree for showing an example by analyzing a structured document to which an identifier is added from said identifier giving unit; and
a structure tree for showing an example created at said structure analysis section for showing an example is presented to the user, an identifier added to the search target element is obtained by receiving an input of a search target element from the user, and to input the obtained identifier to the search expression creating unit.

3. The search expression creating system according to claim 1, wherein;
said search expression creating unit has a structure analysis section for search which creates a structure tree for search by analyzing structured document to which an identifier is added by said identifier giving unit; and
receives an input of an identifier corresponding to said search target element from said search element specifying unit, searches an element having said inputted identifier from a structure tree for search created at said structure analysis section for search, and creates a search expression showing a structural in position of said searched element in said structure tree for search.

4. The search expression creating system according to 1, wherein;
said search expression creating unit has a plurality of structure analysis section for search which creates a structure tree for search by analyzing originally a structured document to which an identifier is added by said identifier giving unit, searches an element having said inputted identifier from each structure tree for search created at said each structure analysis section for search, and generates a search expression indicating a structural position of said searched element at a structure tree for search for every structure analysis section for search.

5. The search expression creating system according to claim 1, wherein said structured document is a document represented by HTML.

6. The search expression creating system according to claim 1 wherein said search expression creating unit saves a generated search expression by using a search expression correspondence table corresponded to each type of a structure analysis.

7. The search expression creating system according to claim 1, wherein said search expression creating unit generates HTML editing command using a generated search expression.

8. A search expression creating method, comprising:
adding an identifier to an element of a structured document as an attribute independent of structure analysis;
analyzing the structured document to which the identifier is added, receiving an input of the search target element from the user, and obtaining the identifier added to the inputted search target element; and
analyzing a structured document to which the identifier is added, receiving an input of an identifier corresponding to said search target element, searching the search target element from analyzed structure by using the inputted identifier, and creating a search expression indicating the structural position of said search target element.

9. The search expression creating method according to claim 8, wherein:
creating a structure tree for showing an example by analyzing a structured document to which an identifier is added; and
said structure tree for showing an example created is presented to the user, an identifier added to the search target element is obtained by receiving an input of a search target element from the user, and to input the obtained identifier.

10. The search expression creating method according to claim 8, wherein;
creating a structure tree for search by analyzing structured document to which an identifier is added; and
receiving an input of an identifier corresponding to said search target element searching an element having said inputted identifier from a structure tree for search created, and creating a search expression showing a structural position of said searched element in said structure tree for search.

11. A recording medium which stores a search expression generation program to be used in a search expression creating system having a memory unit and operation input unit, having a computer to realize;
an identifier giving function which stores a memory unit by adding an identifier to an element of a structured document as an attribute independent of structure analysis read from said memory unit or obtained from an external terminal;
a search element specifying function which reads and analyzes the structured document to which the identifier is added from said memory unit, receives an input of the search target element by said operation input means unit from the user, and obtains the identifier added to the inputted search target element; and
a search expression creating function which reads and analyzes the structured document to which the identifier is added from said memory unit, receives an input of the identifier corresponding to the search target element from said search element specifying function, searches the search target element from the analyzed structure by using the inputted identifier, and generates a search expression indicating the structural position of said search target element.

12. The recording medium who stores a search expression generation program according to claim 11, wherein:
said search expression creating function has a structure analysis function for showing an example to be stored in said memory unit by analyzing a structured document to which an identifier is added by said identifier giving unit and creating a structure tree for showing an example,
displays a structure tree for showing an example created at said structure analysis function for showing an example, obtains an identifier added to the search target element by receiving an input of search target element by said operation input unit from the user, and inputs the obtained identifier.

13. The recording medium which stores a search expression generation program according to claim 11, wherein;
said search expression creating function has a structure analysis function for search which analyzes a structured document to which an identifier is added by said identifier giving function, and stores to said memory unit by creating a structure tree for search; and
receives an input of an identifier corresponding to said search target element from said search element specifying unit, reads a structure tree for search created at said structure analysis function for search from said memory unit, searches an element having said inputted identifier from said structure tree for search, and generates a search expression indicating a structural position of said searched element at said structure tree for search.

14. (canceled)
